(19) United States
(12) Patent Application Publication
(10) Pub. No.: US 2026/0106960 A1
(43) Pub. Date: Apr. 16, 2026

(54) THREE-DIMENSIONAL RECONSTRUCTION METHOD AND APPARATUS, TERMINAL, AND STORAGE MEDIUM

(71) Applicants: Beijing Zitiao Network Technology Co., Ltd., Beijing (CN); Peking University, Beijing (CN)

(72) Inventors: Chenguo LIN, Beijing (CN); Panwang PAN, Beijing (CN); Yadong MU, Beijing (CN)

(21) Appl. No.: 19/359,411

(22) Filed: Oct. 15, 2025

(30) Foreign Application Priority Data
Oct. 15, 2024 (CN) 202411441674.5

(51) Int. Cl. H04N 13/282; H04N 13/261; H04N 13/275

(52) U.S. Cl. CPC H04N 13/282; H04N 13/261; H04N 13/275

(57) ABSTRACT

The present disclosure provides a three-dimensional reconstruction method and apparatus, a terminal, and a storage medium. The three-dimensional reconstruction method includes: inputting a single-view image and a camera position thereof into a trained diffusion model; outputting, by the diffusion model, three-dimensional Gaussian splatting parameters corresponding to an object in the single-view image; and performing three-dimensional object rendering using the three-dimensional Gaussian splatting parameters, to obtain a reconstructed three-dimensional object

### CROSS-REFERENCE TO RELATED APPLICATION(S)

This application claims priority to Chinese Application No. 202411441674.5 filed Oct. 15, 2024, the disclosure of which is incorporated herein by reference in its entity.

### FIELD

The present disclosure relates to the field of information technology, and in particular, to a three-dimensional reconstruction method and apparatus, a terminal, and a storage medium.

### BACKGROUND

Reconstructing a three-dimensional object based on a single-view image is a typical ill-posed problem, which is widely applied in fields such as game development, film production, industrial generation, and electronic design.

### SUMMARY

The present disclosure provides a three-dimensional reconstruction method and apparatus, a terminal, and a storage medium.

The present disclosure uses the following technical solutions.

An embodiment of the present disclosure provides a three-dimensional reconstruction method. The three-dimensional reconstruction method includes: inputting a single-view image and a camera position thereof into a trained diffusion model; outputting, by the diffusion model, three-dimensional Gaussian splatting parameters corresponding to an object in the single-view image; and performing three-dimensional object rendering using the three-dimensional Gaussian splatting parameters, to obtain a reconstructed three-dimensional object.

Another embodiment of the present disclosure provides a three-dimensional reconstruction apparatus. The processing apparatus includes: an input module, configured to input a single-view image and a camera position thereof into a trained diffusion model; an output module, configured to output, by the diffusion model, three-dimensional Gaussian splatting parameters corresponding to an object in the single-view image; and a rendering module, configured to perform three-dimensional object rendering using the three-dimensional Gaussian splatting parameters, to obtain a reconstructed three-dimensional object.

In some embodiments, the present disclosure provides a terminal, including at least one memory and at least one processor, where the memory is configured to store program code, and the processor is configured to invoke the program code stored in the memory to perform the above-mentioned three-dimensional reconstruction method.

In some embodiments, the present disclosure provides a storage medium, where the storage medium is configured to store program code, and the program code is used to perform the above-mentioned three-dimensional reconstruction method.

### BRIEF DESCRIPTION OF THE DRAWINGS

The above-mentioned and other features, advantages, and aspects of embodiments of the present disclosure become more apparent with reference to the accompanying drawings and the following specific implementations. Throughout the accompanying drawings, the same or similar reference numerals denote the same or similar elements. It should be understood that the accompanying drawings are illustrative, and components and elements may not necessarily be drawn to scale.

FIG. 1 is a flowchart of a three-dimensional reconstruction method according to an embodiment of the present disclosure.

FIG. 2 illustrates a structural diagram of a diffusion model according to some embodiments.

FIG. 3 illustrates a multi-view three-dimensional Gaussian reconstruction process according to some embodiments.

FIG. 4 illustrates a reconstruction effect of a single-view three-dimensional object according to an embodiment of the present disclosure.

FIG. 5 illustrates a reconstruction effect of a single-view three-dimensional object according to an embodiment of the present disclosure.

FIG. 6 illustrates a reconstruction effect of a single-view three-dimensional object according to an embodiment of the present disclosure.

FIG. 7 illustrates a reconstruction result corresponding to the same input image and different text description information according to an embodiment of the present disclosure.

FIG. 8 illustrates a reconstruction result corresponding to the same input image and different text description information according to an embodiment of the present disclosure.

FIG. 9 illustrates partial modules of a three-dimensional reconstruction apparatus according to another embodiment of the present disclosure.

FIG. 10 is a schematic structural diagram of an electronic device according to an embodiment of the present disclosure.

### DETAILED DESCRIPTION OF EMBODIMENTS

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

It should be understood that the steps recorded in the method implementations in the present disclosure may be performed in different orders and/or in parallel. Additionally, additional steps may be included and/or the execution of the illustrated steps may be omitted in the method implementations. The scope of the present disclosure is not limited in this aspect.

The term “including” used herein and variations thereof are open-ended inclusions, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. Related definitions of other terms will be given in the description below.

It should be noted that concepts such as “first” and “second” mentioned in the present disclosure are only used to distinguish different apparatuses, modules, or units, and are not used to limit the order or relation of interdependence of functions performed by these apparatuses, modules, or units.

It should be noted that the modification of “a” mentioned in the present disclosure is illustrative rather than limiting, and those skilled in the art should understand that unless otherwise explicitly specified in the context, it should be interpreted as “one or more”.

The names of messages or information exchanged between a plurality of apparatuses in the implementations of the present disclosure are used for illustrative purposes only, and are not used to limit the scope of these messages or information.

As mentioned above, reconstructing a three-dimensional object based on a single-view image is a typical ill-posed problem, which is widely applied in fields such as game development, film production, industrial generation, and electronic design. The challenge of the task lies in the fact that the reconstructed three-dimensional object needs to not only match an appearance of an input image from an input view but also exhibit a geometrically plausible structure from any other view. However, through the reconstruction method, an overall appearance and geometric information of an arbitrary object are inferred only from the input image, posing significant challenges to the accuracy and generalizability of the method. Meanwhile, in practical application scenarios, there is a high requirement for the speed of the reconstruction method to enhance use experience of users and production efficiency.

A commonly used single-view 3D object reconstruction technique is called CAT3D (Create Anything in 3D with Multi-View Diffusion Models). The method uses an image generation model to first generate images of an object from a plurality of specified new views, using the single-view image as a constraint. Subsequently, the plurality of generated images with camera views are used to reconstruct the three-dimensional object through a multi-view reconstruction method, namely, a neural radiance field (NeRF).

The image generation model, due to the absence of three-dimensional constraints inside, is essentially engaged in a probability distribution prediction problem on a two-dimensional plane. Consequently, generated multi-view images have the problem of three-dimensional inconsistency. The use of the multi-view images with the three-dimensional inconsistency as inputs for subsequent steps severely undermines the final reconstruction quality. Additionally, the generation of the multi-view images is solely guided by a single input image from the input view, making it impossible to control ambiguous single-view reconstructions through textual instructions, and as a result, user controllability in a reconstruction generation process is greatly reduced. Further, an existing reconstruction pipeline is composed of two unrelated modules. The first step of multi-view image generation typically takes less than 10 seconds, whereas the second step of reconstructing a single three-dimensional neural radiance field from the multi-view images often takes tens of minutes, resulting in inefficient reconstruction. Moreover, the ray tracing technology is used for rendering of the reconstructed NeRF. To render a single pixel, hundreds of points need to be sampled along a ray propagation path for instantaneous computation, leading to high computational costs for rendering after training. Therefore, further improvements in this aspect are expected.

In the present disclosure, the three-dimensional Gaussian splatting parameters are directly generated through the single-view image, a capability of three-dimensional perceptibility is provided, and a problem of three-dimensional inconsistency is solved. Additionally, in the present disclosure, a reconstruction pipeline is composed of a single diffusion model, without the need for an additional model component, thereby improving the efficiency of the reconstruction generation pipeline. Additionally, in the aspect of three-dimensional representation reconstruction, a multi-view three-dimensional Gaussian splatting representation is used in the present disclosure to enhance the rendering quality and speed, thereby rapidly and accurately rendering the reconstructed three-dimensional object.

The present disclosure represents an object using multi-view three-dimensional Gaussian splatting (3DGS) and directly generates various parameters of the 3DGS through diffusion models, thereby significantly improving the rendering quality and generation speed of single-view three-dimensional object reconstruction.

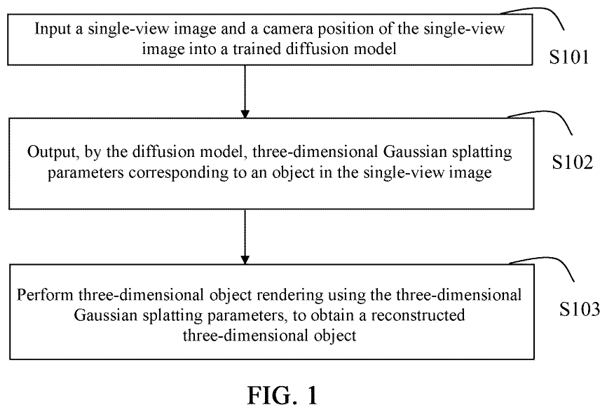

FIG. 1 provides a flowchart of a three-dimensional reconstruction method according to an embodiment of the present disclosure. The three-dimensional reconstruction method in the present disclosure may include step S101: A single-view image and a camera position thereof are input into a trained diffusion model. In some embodiments, the single-view image is a typical two-dimensional image. In some embodiments, the camera position represents angular information for capturing the single-view image, such as 0°, 60°, and 180°. In some embodiments, the trained diffusion model may include a trained convolutional neural network, etc., which is a type of generative model, and an execution process includes a noising process (a forward process) and a denoising process (a reverse process).

In some embodiments, the method in the present disclosure may further include step S102: Three-dimensional Gaussian splatting parameters corresponding to an object in the single-view image are output by the diffusion model. The diffusion model in the present disclosure can be trained to output the three-dimensional Gaussian splatting parameters corresponding to the object in the single-view image based on the single-view image and the camera position thereof, thereby achieving three-dimensional reconstruction of the object in the single-view image. In some embodiments, in this phase, the diffusion model receives conditional information such as noise sampled from a random distribution, the single-view image, and the fixed camera position thereof, and obtains the three-dimensional Gaussian splatting parameters representing the three-dimensional object after an iterative denoising process.

In some embodiments, the method in the present disclosure may further include step S103: three-dimensional object rendering is performed using the three-dimensional Gaussian splatting parameters, to obtain a reconstructed three-dimensional object. Therefore, compared to an existing object three-dimensional reconstruction method, in the present disclosure, the three-dimensional Gaussian splatting parameters corresponding to the object in the single-view image are output through the diffusion model, and then, the three-dimensional reconstruction of the object is performed using the three-dimensional Gaussian splatting parameters, providing a capability of three-dimensional perceptibility and solving the problem of three-dimensional inconsistency. Additionally, a reconstruction pipeline is composed of a single diffusion model, without the need for an additional model component, thereby improving the efficiency of the reconstruction generation pipeline. Additionally, in the aspect of three-dimensional representation reconstruction, a multi-view three-dimensional Gaussian splatting representation is used to enhance the rendering quality and speed, thereby rapidly and accurately rendering the reconstructed three-dimensional object.

In some embodiments, the step of inputting a single-view image and a camera position thereof into a trained diffusion model includes: inputting the single-view image, as well as corresponding text description information, and the camera position thereof into the trained diffusion model. In addition to image input, the present disclosure incorporates control information of a textual instruction (i.e., the text description information), which may assist in single-view three-dimensional object reconstruction with the text description information, thereby improving the flexibility and user controllability of three-dimensional reconstruction.

In some embodiments, the three-dimensional Gaussian splatting parameters include information such as three-dimensional coordinates, a three-dimensional size, a rotation angle, a color, and opacity. In some embodiments, the step of performing three-dimensional object rendering using the three-dimensional Gaussian splatting parameters includes: performing three-dimensional object rendering using the three-dimensional Gaussian splatting parameters through a rasterization-based three-dimensional Gaussian splatting method. The present disclosure replaces the reconstructed three-dimensional representation with rasterization-based three-dimensional GS instead of NeRF, thereby reducing the rendering cost after training.

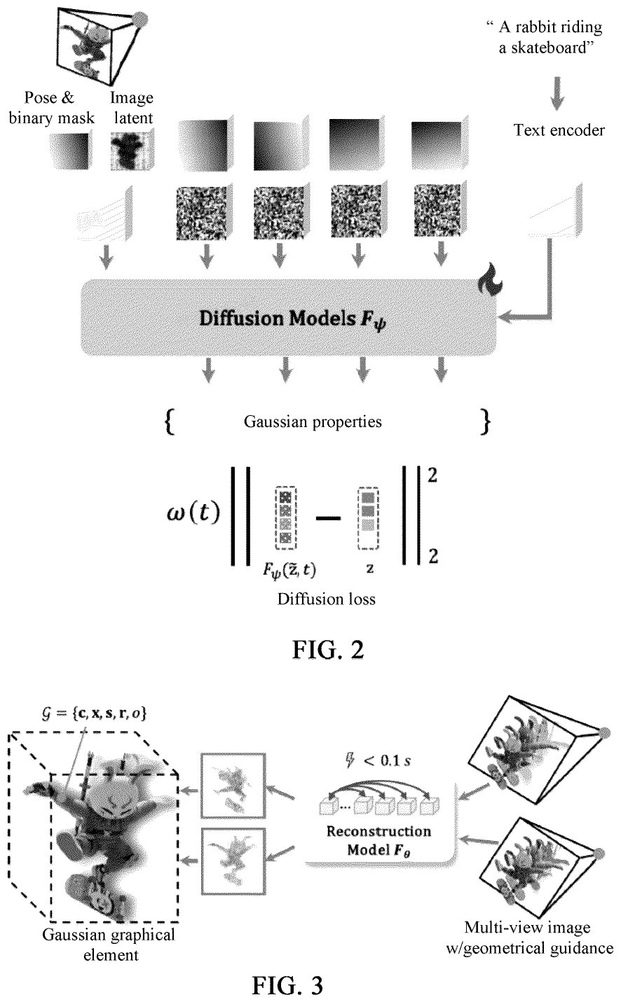

In some embodiments, the three-dimensional reconstruction method in the present disclosure further includes: training the diffusion model to obtain a trained diffusion model before the inputting a single-view image and a camera position thereof into a trained diffusion model. FIG. 2 illustrates a structural diagram of a diffusion model according to some embodiments. In some embodiments, training the diffusion model includes: acquiring a multi-view image; acquiring three-dimensional Gaussian splatting parameters corresponding to the multi-view image; adding randomly sampled noise to the three-dimensional Gaussian splatting parameters corresponding to the multi-view image; inputting the noise-containing three-dimensional Gaussian splatting parameters, one of single-view images from the multi-view image, as well as corresponding text description information and a camera position thereof into the diffusion model; outputting the denoised three-dimensional Gaussian splatting parameters through the diffusion model, and performing supervised network optimization on the diffusion model by using the three-dimensional Gaussian splatting parameters corresponding to the multi-view image before noise addition as a training target, to obtain the trained diffusion model. In some embodiments, the multi-view image may include any suitable number of single-view images. For example, the multi-view image may include 4 single-view images, such as single-view images from the views of 0°, 90°, 180°, and 270°.

In some embodiments, in the present disclosure, an object representation is composed of N three-dimensional Gaussian primitives

$$𝒢 := {\{ {g}_{i} \}}_{i = 1}^{N} ,$$

where gi∈ [symbol] is formed by parameterizing a RGB color c∈ [symbol] , a position x∈ [symbol] , a size s∈ [symbol] , a rotation quaternion r∈ [symbol] , and opacity o∈ [symbol] . To simplify the parameterized representation and constrain a generated three-dimensional Gaussian distribution, the position x is derived from a depth d∈ [symbol] , intrinsic and extrinsic parameters of a camera (the extrinsic parameters: R∈SO(3) and t∈ [symbol] , the intrinsic parameter K∈ [symbol] ), and a pixel coordinate u∈ [symbol] .

$$x := {R}^{T} {K}^{- 1} [ u \vert d ] - t$$

In some embodiments, the three-dimensional Gaussian splatting parameters corresponding to the multi-view image are three-dimensional Gaussian splatting parameters normalized to the range of [0, 1]. For a subsequent diffusion generation process, the three-dimensional Gaussian splatting parameters are normalized to the range of [0, 1]. Therefore, when the model predicts the three-dimensional Gaussian parameters, all outputs, except for the rotation quaternion r which undergoes L2-norm, are normalized to the range of [0, 1] through an activation function siginoid(·). The RGB color and the opacity naturally satisfy the range of [0, 1]. To process a size and a depth with uncertain numerical ranges, the present disclosure proposes the following method:
A maximum value Sₘₐₓ and a minimum value Sₘᵢₙ of the three-dimensional Gaussian are specified in advance, and a final Gaussian size is interpolated from an initial value A between the maximum value and the minimum value.

$$s := {s}_{min} \cdot sigmoid ( \hat{s} ) + {s}_{max} \cdot ( 1 - sigmoid ( \hat{s} ) )$$

Instead of directly modeling a true depth value, since the object may be normalized to [−1, 1]³, a depth d relative to an image projection plane is modeled:

$$d := 2 \cdot sigmoid ( \hat{d} ) - 1 + {‖ t ‖}_{2}$$

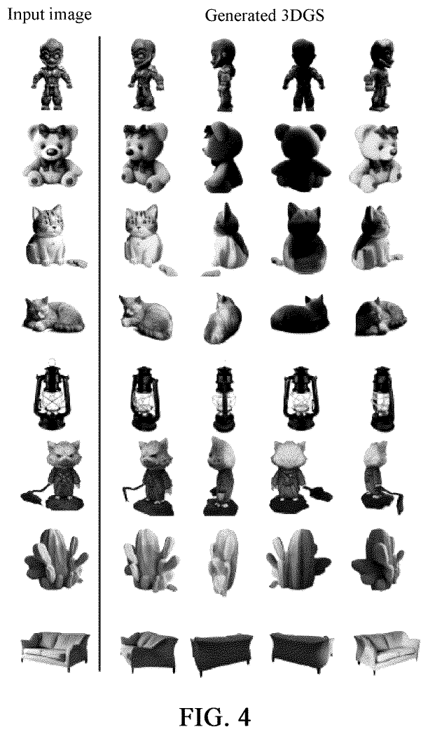

In some embodiments, the acquiring three-dimensional Gaussian splatting parameters corresponding to the multi-view image includes: acquiring the three-dimensional Gaussian splatting parameters corresponding to the multi-view image by a reconstruction model based on the multi-view image, as well as normal maps and coordinate maps corresponding to the multi-view image. As shown in FIG. 3, a multi-view three-dimensional Gaussian representation is obtained from the multi-view image through a lightweight reconstruction model within 0.1 seconds. Unlike a previous method in which the multi-view image is only used as reconstruction information, in a training phase, the present disclosure additionally uses the normal maps and the coordinate maps, thereby greatly improving the reconstruction quality of the three-dimensional Gaussian representation. It should be noted that the additional normal maps and coordinate maps are only required in the training phase and are not needed during deployment for inference in practical applications.

In some embodiments, the reconstruction model may adopt any existing model for acquiring three-dimensional Gaussian splatting parameters, or may be trained independently, for example, using a labeled dataset where labels are known three-dimensional Gaussian parameters. Typically, an encoder-decoder structure may be adopted, where an encoder is used to extract features from the multi-view image, and a decoder converts these features into required three-dimensional Gaussian parameters. In the present disclosure, by adopting the additional normal maps and coordinate maps, the normal maps provide normal directions of a surface at all pixel points, which is very useful for understanding local geometric features of the object surface. The coordinate maps usually represent positions of all the pixel points in an object global coordinate system, which aids the model in understanding a spatial structure of the object. Therefore, the reconstruction quality of the three-dimensional Gaussian representation is significantly improved.

As shown in FIG. 2, a network structure of an image diffusion model is adopted in the present disclosure to directly process the three-dimensional Gaussian parameter. Vin-view three-dimensional Gaussian parameters to be generated are organized in an arrangement format [symbol] similar to image pixels, where N=H×W, and H and W respectively correspond a height and a width, meaning each Gaussian primitive is derived from a corresponding pixel. A Plucker view vector representing view information is concatenated with the three-dimensional Gaussian parameter in a feature dimension. Subsequently, the image diffusion model processes a Gaussian parameter for each view independently. In an attention layer, a tensor shape processed by a network is rearranged to [symbol] , where m is a dimension of features, thereby allowing the network to process three-dimensional Gaussian parameters from different views across different views.

To input the single-view image as the conditional information, features of the single-view image are concatenated with the Gaussian parameter in a view dimension. In other words, areal input shape of the network is [symbol] , with an additional dense binary mask (all 0 or all 1) concatenated in the feature dimension to distinguish between the image input as a condition and the Gaussian parameter input as a network processing target.

Different from a previous method for single-view three-dimensional object reconstruction, in addition to input image information, the method of the present disclosure also supports the text description information as the control information to specify generated three-dimensional content. As shown in FIG. 2, a text feature embedding is obtained from the text description information of the object through a text encoder (e.g., a CLIP text encoder or a T5 text encoder). A text feature interacts with a Gaussian parameter feature in the network through a cross attention mechanism, thereby guiding a generation process of the Gaussian parameter.

In some embodiments, the performing supervised network optimization on the diffusion model by using the three-dimensional Gaussian splatting parameters corresponding to the multi-view image before noise addition may include using the three-dimensional Gaussian splatting parameters corresponding to the multi-view image before the noise addition to perform the supervised network optimization on the diffusion model based on the principle of minimizing a Gaussian loss function.

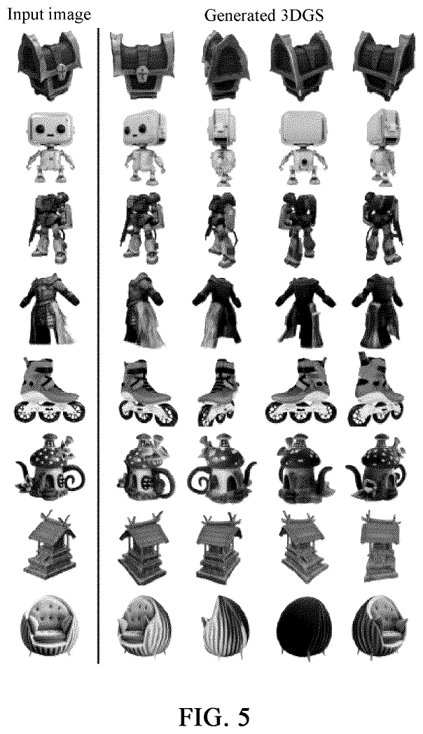

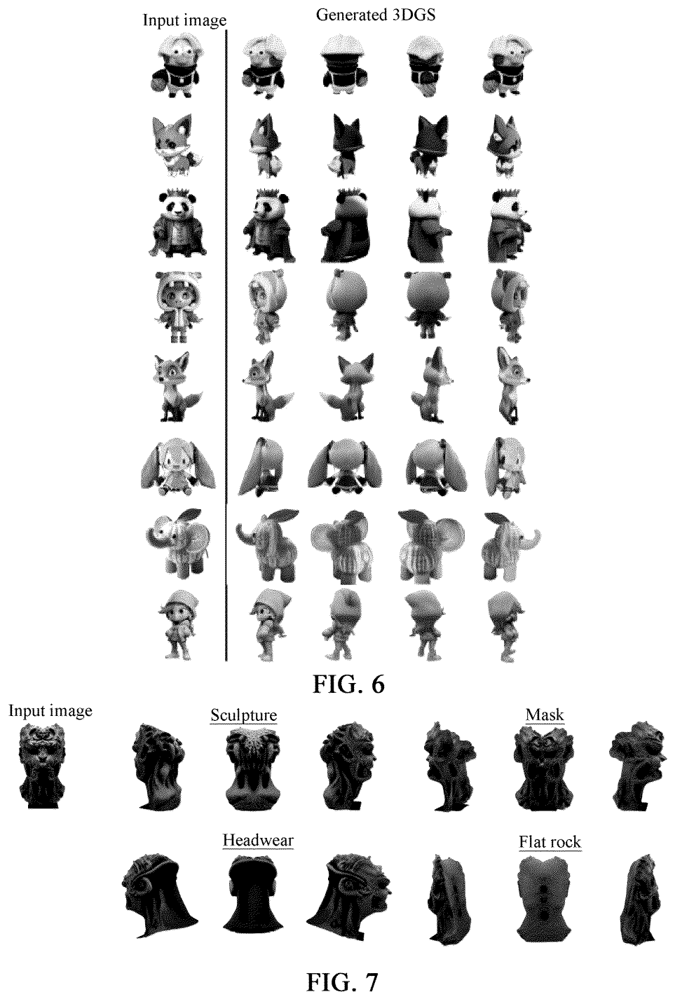

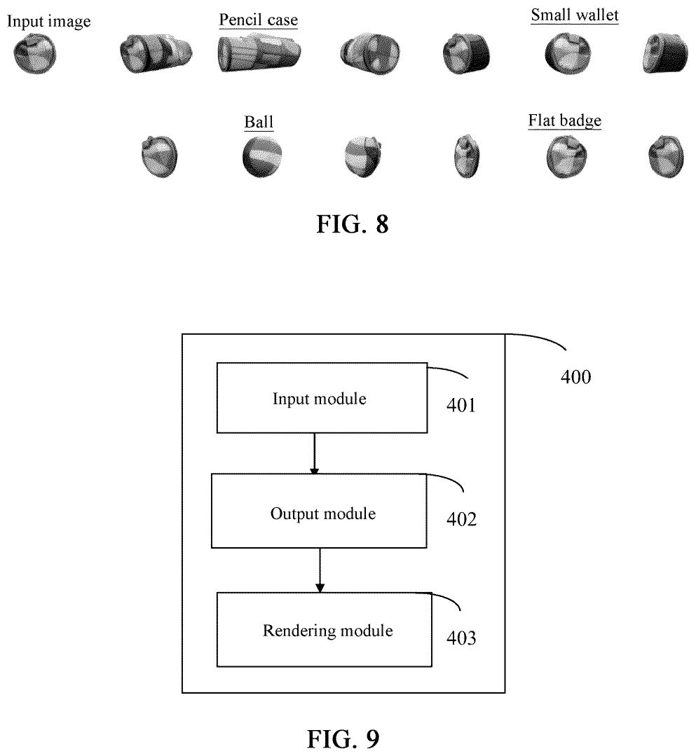

FIG. 4 to FIG. 6 respectively illustrate reconstruction effects of single-view three-dimensional objects according to embodiments of the present disclosure, and FIG. 7 and FIG. 8 respectively illustrate reconstruction results corresponding to the same input image and different text description information according to embodiments of the present disclosure. Due to the direct generation of a high-quality three-dimensional Gaussian parameter, the consistency, namely the accuracy, of a three-dimensional object reconstructed in the present disclosure is significantly improved, with effects shown in FIG. 4, FIG. 5, and FIG. 6. Additionally, due to an additional text control condition, the controllability of a reconstruction pipeline proposed by the present disclosure is greatly enhanced for a user. Effects are shown in FIG. 7 and FIG. 8. For the same single-view image, different text description information may be input to obtain corresponding three-dimensional reconstructed objects. Additionally, due to the adoption of the high-quality multi-view three-dimensional Gaussian splatting technology, the present disclosure not only improves the quality of a final rendered three-dimensional object but also increases the rendering speed, making real-time rendering and interactive applications possible.

In the present disclosure, the normal maps and the coordinate maps are combined in the training phase through a generalizable Gaussian reconstruction model and a carefully designed normalization method, to obtain the high-quality normalized three-dimensional Gaussian splatting parameters from the multi-view image within 0.1 seconds, construct a dataset required for diffusion model training, improve the efficiency of the reconstruction generation pipeline, provide a three-dimensional perception capability, and solve the problem of three-dimensional inconsistency. Additionally, the present disclosure uses the text description information as an additional control condition to guide single-view three-dimensional reconstruction. Through different condition guidance mechanisms, the diffusion model for generating the three-dimensional Gaussian parameter supports both the image and the text description information as control conditions, thereby greatly improving the flexibility and controllability of three-dimensional reconstruction. In the aspect of three-dimensional representation reconstruction, a multi-view three-dimensional Gaussian splatting representation is used to enhance the rendering quality and speed, thereby rapidly and accurately rendering the reconstructed three-dimensional object.

An embodiment of the present disclosure further provides a three-dimensional reconstruction apparatus 400. FIG. 9 illustrates a three-dimensional reconstruction apparatus 400 according to some embodiments. The three-dimensional reconstruction apparatus 400 includes an input module 401, an output module 402, and a rendering module 403. In some embodiments, the input module 401 is configured to input a single-view image and a camera position thereof into a trained diffusion model. In some embodiments, the output module 402 is configured to output, by the diffusion model, three-dimensional Gaussian splatting parameters corresponding to an object in the single-view image. In some embodiments, the rendering module 403 is configured to perform three-dimensional object rendering using the three-dimensional Gaussian splatting parameters, to obtain a reconstructed three-dimensional object.

It should be understood that the content described about the three-dimensional reconstruction method is also applicable to the three-dimensional reconstruction apparatus 400 herein, and for the sake of brevity, no detailed description is provided herein.

In some embodiments, the step of inputting a single-view image and a camera position thereof into a trained diffusion model includes: inputting the single-view image, as well as corresponding text description information, and the camera position thereof into the trained diffusion model. In some embodiments, the three-dimensional Gaussian splatting parameters include three-dimensional coordinates, a three-dimensional size, a rotation angle, a color, and opacity. In some embodiments, the step of performing three-dimensional object rendering using the three-dimensional Gaussian splatting parameters includes: performing three-dimensional object rendering using the three-dimensional Gaussian splatting parameters through a rasterization-based three-dimensional Gaussian splatting method. In some embodiments, the three-dimensional reconstruction apparatus further includes: a training module, configured to train the diffusion model to obtain a trained diffusion model before the inputting a single-view image and a camera position thereof into a trained diffusion model, where the step of training the diffusion model includes: acquiring a multi-view image; acquiring three-dimensional Gaussian splatting parameters corresponding to the multi-view image; adding randomly sampled noise to the three-dimensional Gaussian splatting parameters corresponding to the multi-view image; inputting the noise-containing three-dimensional Gaussian splatting parameters, one of single-view images from the multi-view image, as well as corresponding text description information and a camera position thereof into the diffusion model; and outputting the denoised three-dimensional Gaussian splatting parameters through the diffusion model, and performing supervised network optimization on the diffusion model by using the three-dimensional Gaussian splatting parameters corresponding to the multi-view image before noise addition, thereby obtaining the trained diffusion model. In some embodiments, the three-dimensional Gaussian splatting parameters corresponding to the multi-view image are three-dimensional Gaussian splatting parameters normalized to the range of [0, 1]. In some embodiments, the acquiring three-dimensional Gaussian splatting parameters corresponding to the multi-view image includes: acquiring the three-dimensional Gaussian splatting parameters corresponding to the multi-view image by a reconstruction model based on the multi-view image, as well as normal maps and coordinate maps corresponding to the multi-view image. In some embodiments, in the diffusion model, the text description information is processed by a text encoder to obtain a text feature, and the text feature interacts with a three-dimensional Gaussian splatting parameter feature through a cross attention mechanism.

Additionally, the present disclosure further provides a terminal, including at least one memory and at least one processor, where the memory is configured to store program code, and the processor is configured to invoke the program code stored in the memory to perform the above-mentioned three-dimensional reconstruction method.

Additionally, the present disclosure further provides a computer storage medium. The computer storage medium has program code stored therein. The program code is used to perform the above-mentioned three-dimensional reconstruction method.

The above is a description of the three-dimensional reconstruction method and apparatus of the present disclosure based on the embodiments and application examples. Additionally, the present disclosure further provides a terminal and a storage medium. The terminal and the storage medium are described below.

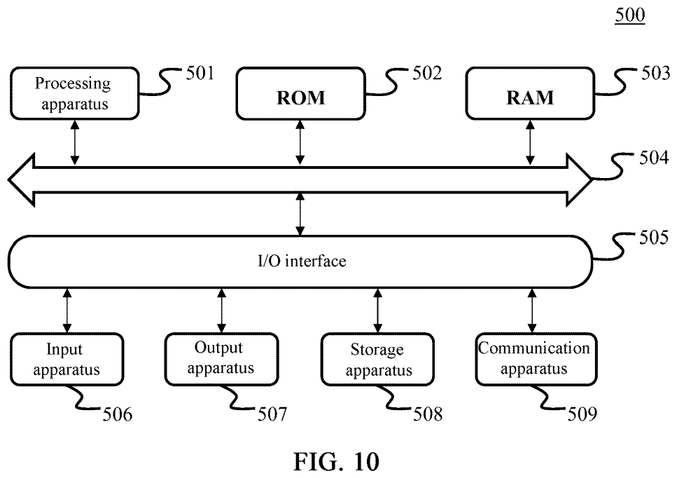

Referring to FIG. 10 below, FIG. 10 illustrates a schematic structural diagram of an electronic device (e.g., a terminal device or a server) 500 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a portable Android device (PAD), a portable media player (PMP), and a vehicle-mounted terminal (e.g., a vehicle navigation terminal), and fixed terminals such as a digital TV and a desktop computer. The electronic device shown in FIG. 10 is merely an example, and should not impose any limitation on the function and scope of use of the embodiments of the present disclosure.

As shown in FIG. 10, the electronic device 500 may include a processing apparatus (e.g., a central processing unit and a graphics processing unit) 501, which may perform various suitable actions and processing based on a program stored in a read only memory (ROM) 502 or a program loaded from a storage apparatus 508 into a random-access memory (RAM) 503. The RAM 503 further stores various programs and data needed by the operation of the electronic device 500. The processing apparatus 501, the ROM 502, and the RAM 503 are connected to one another through a bus 504. An input/output (I/O) interface 505 is also connected to the bus 504.

Typically, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a magnetic tape and a hard drive; and a communication apparatus 509. The communication apparatus 509 may allow the electronic device 500 to be in wireless or wired communication with other devices for data exchange. Although FIG. 10 illustrates the electronic device 500 having various apparatuses, it should be understood that it is not required to implement or have all of the shown apparatuses. It may be an alternative to implement or have more or fewer apparatuses.

In particular, according to the embodiments of the present disclosure, the process described above with reference to the flowchart may be implemented as a computer software program. For example, an embodiment of the present disclosure includes a computer program product including a computer program carried on a computer-readable medium. The computer program includes program code for performing the method shown in the flowchart. In this embodiment, the computer program may be downloaded and installed from the network through the communication apparatus 509, installed from the storage apparatus 508, or installed from the ROM 502. When the computer program is executed by the processing apparatus 501, the above-mentioned functions defined in the method of the embodiment of the present disclosure are performed.

It should be noted that the above-mentioned computer-readable medium in the present disclosure may be either a computer-readable signal medium or a computer-readable storage medium, or any combination of the two. The computer-readable storage medium may be, for example but is not limited to, electric, magnetic, optical, electromagnetic, infrared, or semiconductor systems, apparatuses, or devices, or any combination thereof. More specific examples of the computer-readable storage medium may include, but are not limited to: an electrical connection with one or more wires, a portable computer disk, a hard drive, a random access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination of the above. In the present disclosure, the computer-readable storage medium may be any tangible medium including or storing a program, and the program may be for use by or for use in conjunction with an instruction execution system, apparatus, or device. However, in the present disclosure, the computer-readable signal medium may include a data signal propagated in a baseband or as apart of a carrier, where the data signal carries computer-readable program code. The propagated data signal may take various forms, including but not limited to, an electromagnetic signal, an optical signal, or any suitable combination of the above. The computer-readable signal medium may further be any computer-readable medium other than the computer-readable storage medium. The computer-readable signal medium may send, propagate, or transmit a program for use by or for use in conjunction with the instruction execution system, apparatus, or device. The program code included in the computer-readable medium may be transmitted by any suitable medium including but not limited to a wire, an optical cable, radio frequency (RF), etc., or any suitable combination of the above.

In some implementations, a client and a server may communicate using any currently known or future-developed network protocols such as a hypertext transfer protocol (HTTP), and may be interconnected with digital data communication in any form or medium (e.g., a communication network). Examples of the communication network include a local area network (“LAN”), a wide area network (“WAN”), Internet work (e.g., Internet), a peer-to-peer network (e.g., an ad hoc peer-to-peer network), and any currently known or future-developed networks.

The above-mentioned computer-readable medium may be included in the above-mentioned electronic device; or may also separately exist without being assembled in the electronic device.

The computer-readable medium carries one or more programs. The one or more programs, when executed by the electronic device, cause the electronic device to perform the above-mentioned method of the present disclosure.

Computer program code for performing the operations of the present disclosure may be written in one or more programming languages or a combination thereof. The above-mentioned programming languages include object-oriented programming languages such as Java, Smalltalk, and C++, and further include conventional procedural programming languages such as “C” language or similar programming languages. The program code may be executed entirely on a user computer, partly on the user computer, as a stand-alone software package, partly on the user computer and partly on a remote computer, or entirely on the remote computer or the server. In the case of the remote computer, the remote computer may be connected to the user computer through any kind of network, including a local area network (LAN) or a wide area network (WAN), or may be connected to an external computer (e.g., utilizing an Internet service provider for Internet connectivity).

The flowcharts and the block diagrams in the accompanying drawings illustrate the possibly implemented system architecture, functions, and operations of the system, the method, and the computer program product according to various embodiments of the present disclosure. In this regard, each block in the flowcharts or the block diagrams may represent a module, a program segment, or a part of code, and the module, the program segment, or the part of code contains one or more executable instructions for implementing specified logical functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented using a dedicated hardware-based system that performs specified functions or operations, or may be implemented using a combination of dedicated hardware and computer instructions.

The involved units described in the embodiments of the present disclosure may be implemented through software or hardware. The name of the unit does not limit the unit itself in certain cases.

Herein, the functions described above may be at least partially executed by one or more hardware logic components. For example, without limitation, exemplary hardware logic components that can be used include: a field-programmable gate array (FPGA), an application-specific integrated circuit (ASIC), an application-specific standard product (ASSP), a system on chip (SOC), a complex programmable logic device (CPLD), etc.

In the context of the present disclosure, a machine-readable medium may be a tangible medium that may include or store a program for use by or for use in conjunction with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above-mentioned content. More specific examples of the machine-readable storage medium may include an electrical connection based on one or more wires, a portable computer disk, a hard drive, a random access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination of the above-mentioned content.

According to one or more embodiments of the present disclosure, a three-dimensional reconstruction method is provided. The three-dimensional reconstruction method includes: inputting a single-view image and a camera position thereof into a trained diffusion model; outputting, by the diffusion model, three-dimensional Gaussian splatting parameters corresponding to an object in the single-view image; and performing three-dimensional object rendering using the three-dimensional Gaussian splatting parameters, to obtain a reconstructed three-dimensional object.

According to one or more embodiments of the present disclosure, the inputting a single-view image and a camera position thereof into a trained diffusion model includes: inputting the single-view image, as well as corresponding text description information, and the camera position thereof into the trained diffusion model.

According to one or more embodiments of the present disclosure, the three-dimensional Gaussian splatting parameters include three-dimensional coordinates, a three-dimensional size, a rotation angle, a color, and opacity.

According to one or more embodiments of the present disclosure, the performing three-dimensional object rendering using the three-dimensional Gaussian splatting parameters includes: performing three-dimensional object rendering using the three-dimensional Gaussian splatting parameters through a rasterization-based three-dimensional Gaussian splatting method.

According to one or more embodiments of the present disclosure, the three-dimensional reconstruction method further includes: training the diffusion model to obtain a trained diffusion model before the inputting a single-view image and a camera position thereof into a trained diffusion model, where the training the diffusion model includes: acquiring a multi-view image; acquiring three-dimensional Gaussian splatting parameters corresponding to the multi-view image; adding randomly sampled noise to the three-dimensional Gaussian splatting parameters corresponding to the multi-view image; inputting the three-dimensional Gaussian splatting parameters with the noise, one of single-view images from the multi-view image, as well as corresponding text description information and a camera position thereof into the diffusion model; and outputting the denoised three-dimensional Gaussian splatting parameters through the diffusion model, and performing supervised network optimization on the diffusion model by using the three-dimensional Gaussian splatting parameters corresponding to the multi-view image before noise addition, thereby obtaining the trained diffusion model.

According to one or more embodiments of the present disclosure, the three-dimensional Gaussian splatting parameters corresponding to the multi-view image are three-dimensional Gaussian splatting parameters normalized to the range of [0, 1].

According to one or more embodiments of the present disclosure, the acquiring three-dimensional Gaussian splatting parameters corresponding to the multi-view image includes: acquiring the three-dimensional Gaussian splatting parameters corresponding to the multi-view image by a reconstruction model based on the multi-view image, as well as normal maps and coordinate maps corresponding to the multi-view image.

According to one or more embodiments of the present disclosure, in the diffusion model, the text description information is processed by a text encoder to obtain a text feature, and the text feature interacts with a three-dimensional Gaussian splatting parameter feature through a cross attention mechanism.

According to one or more embodiments of the present disclosure, a three-dimensional reconstruction apparatus is provided. The three-dimensional reconstruction apparatus includes: an input module, configured to input a single-view image and a camera position thereof into a trained diffusion model; an output module, configured to output, by the diffusion model, three-dimensional Gaussian splatting parameters corresponding to an object in the single-view image; and a rendering module, configured to perform three-dimensional object rendering using the three-dimensional Gaussian splatting parameters, to obtain a reconstructed three-dimensional object.

According to one or more embodiments of the present disclosure, a terminal is provided, and includes at least one memory and at least one processor, where the at least one memory is configured to store program code, and the at least one processor is configured to invoke the program code stored in the at least one memory to perform any of the above-mentioned methods.

According to one or more embodiments of the present disclosure, a storage medium is provided. The storage medium is configured to store program code. The program code is used to perform the above-mentioned method.

What are described above are only preferred embodiments of the present disclosure and explanations of the technical principles applied. Those skilled in the art should understand that the scope of the disclosure involved in the present disclosure is not limited to the technical solutions formed by specific combinations of the above technical features, and shall also cover other technical solutions formed by any combination of the above technical features or equivalent features thereof without departing from the above concept of disclosure, such as a technical solution formed by replacing the above features with the technical features with similar functions disclosed (but not limited to) in the present disclosure.

Further, although the operations are described in a particular order, it should not be understood as requiring these operations to be performed in the shown particular order or in a sequential order. In certain environments, multitasking and parallel processing may be advantageous. Similarly, although several specific implementation details are included in the above-mentioned discussion, these specific implementation details should not be interpreted as limitations on the scope of the present disclosure. Some features that are described in the context of separate embodiments may also be implemented in combination in a single embodiment. In contrast, various features described in the context of a single embodiment may also be implemented in a plurality of embodiments individually or in any suitable subcombination.

Although the subject matter has been described in a language specific to structural features and/or logic actions of the method, it should be understood that the subject matter defined in the appended claims is not necessarily limited to the specific features or actions described above. On the contrary, the specific features and the actions described above are merely example forms for implementing the claims.

I/We claim:

1. A three-dimensional reconstruction method, comprising:
inputting a single-view image and a camera position of the single-view image into a trained diffusion model;
outputting, by the diffusion model, three-dimensional Gaussian splatting parameters corresponding to an object in the single-view image; and
performing three-dimensional object rendering by using the three-dimensional Gaussian splatting parameters, to obtain a reconstructed three-dimensional object.

2. The three-dimensional reconstruction method according to claim 1, wherein inputting the single-view image and the camera position into the trained diffusion model comprises: inputting the single-view image, text description information corresponding to the single-view image, and the camera position into the trained diffusion model.

3. The three-dimensional reconstruction method according to claim 1, wherein the three-dimensional Gaussian splatting parameters comprise three-dimensional coordinates, a three-dimensional size, a rotation angle, a color, and opacity.

4. The three-dimensional reconstruction method according to claim 1, wherein performing the three-dimensional object rendering by using the three-dimensional Gaussian splatting parameters comprises: performing the three-dimensional object rendering by using the three-dimensional Gaussian splatting parameters through a rasterization-based 3D Gaussian splatting approach.

5. The three-dimensional reconstruction method according to claim 1, further comprising: training a diffusion model to obtain the trained diffusion model before inputting the single-view image and the camera position into the trained diffusion model,
wherein training the diffusion model comprises:
acquiring a multi-view image;
acquiring three-dimensional Gaussian splatting parameters corresponding to the multi-view image;
adding randomly sampled noise to the three-dimensional Gaussian splatting parameters corresponding to the multi-view image;
inputting the three-dimensional Gaussian splatting parameters with the noise, one of single-view images from the multi-view image, as well as text description information and a camera position corresponding to the single-view image into the diffusion model; and
outputting denoised three-dimensional Gaussian splatting parameters through the diffusion model, and performing supervised network optimization on the diffusion model by using the three-dimensional Gaussian splatting parameters corresponding to the multi-view image before noise addition, to obtain the trained diffusion model.

6. The three-dimensional reconstruction method according to claim 5, wherein the three-dimensional Gaussian splatting parameters corresponding to the multi-view image are three-dimensional Gaussian splatting parameters normalized to the range of [0, 1].

7. The three-dimensional reconstruction method according to claim 5, wherein acquiring the three-dimensional Gaussian splatting parameters corresponding to the multi-view image comprises: acquiring the three-dimensional Gaussian splatting parameters corresponding to the multi-view image by a reconstruction model based on the multi-view image, as well as a normal map and a coordinate map corresponding to the multi-view image.

8. The three-dimensional reconstruction method according to claim 5, wherein, in the diffusion model, the text description information is processed by a text encoder to obtain a text feature, and the text feature interacts with the three-dimensional Gaussian splatting parameter feature through a cross attention mechanism.

9. A terminal, comprising
at least one memory and at least one processor,
wherein the at least one memory is configured to store program code which, when executed by the at least one processor, causes the at least one processor to:
input a single-view image and a camera position of the single-view image into a trained diffusion model;
output, by the diffusion model, three-dimensional Gaussian splatting parameters corresponding to an object in the single-view image; and
perform three-dimensional object rendering by using the three-dimensional Gaussian splatting parameters, to obtain a reconstructed three-dimensional object.

10. The terminal according to claim 9, wherein the program code causing the at least one processor to input the single-view image and the camera position into the trained diffusion model further causes the at least one processor to: input the single-view image, text description information corresponding to the single-view image, and the camera position into the trained diffusion model.

11. The terminal according to claim 9, wherein the three-dimensional Gaussian splatting parameters comprise three-dimensional coordinates, a three-dimensional size, a rotation angle, a color, and opacity.

12. The terminal according to claim 9, wherein the program code causing the at least one processor to perform the three-dimensional object rendering by using the three-dimensional Gaussian splatting parameters further causes the at least one processor to: perform the three-dimensional object rendering by using the three-dimensional Gaussian splatting parameters through a rasterization-based 3D Gaussian splatting approach.

13. The terminal according to claim 9, the program code further causes the at least one processor to: train a diffusion model to obtain the trained diffusion model before inputting the single-view image and the camera position into the trained diffusion model,
wherein the program code causing the at least one processor to train the diffusion model further causes the at least one processor to:
acquire a multi-view image;
acquire three-dimensional Gaussian splatting parameters corresponding to the multi-view image;
add randomly sampled noise to the three-dimensional Gaussian splatting parameters corresponding to the multi-view image;
input the three-dimensional Gaussian splatting parameters with the noise, one of single-view images from the multi-view image, as well as text description information and a camera position corresponding to the single-view image into the diffusion model; and
output denoised three-dimensional Gaussian splatting parameters through the diffusion model, and performing supervised network optimization on the diffusion model by using the three-dimensional Gaussian splatting parameters corresponding to the multi-view image before noise addition, to obtain the trained diffusion model.

14. The terminal according to claim 13, wherein the three-dimensional Gaussian splatting parameters corresponding to the multi-view image are three-dimensional Gaussian splatting parameters normalized to the range of [0, 1].

15. The terminal according to claim 13, wherein the program code causing the at least one processor to acquire the three-dimensional Gaussian splatting parameters corresponding to the multi-view image further causes the at least one processor to: acquire the three-dimensional Gaussian splatting parameters corresponding to the multi-view image by a reconstruction model based on the multi-view image, as well as a normal map and a coordinate map corresponding to the multi-view image.

16. The terminal according to claim 13, wherein, in the diffusion model, the text description information is processed by a text encoder to obtain a text feature, and the text feature interacts with the three-dimensional Gaussian splatting parameter feature through a cross attention mechanism.

17. A non-transitory storage medium, wherein the storage medium is configured to store program code which, when executed by a computer, causes the computer to:
input a single-view image and a camera position of the single-view image into a trained diffusion model;
output, by the diffusion model, three-dimensional Gaussian splatting parameters corresponding to an object in the single-view image; and
perform three-dimensional object rendering by using the three-dimensional Gaussian splatting parameters, to obtain a reconstructed three-dimensional object.

18. The non-transitory storage medium according to claim 17, wherein the program code causing the computer to input the single-view image and the camera position into the trained diffusion model further causes the computer to: input the single-view image, text description information corresponding to the single-view image, and the camera position into the trained diffusion model.

19. The non-transitory storage medium according to claim 17, wherein the three-dimensional Gaussian splatting parameters comprise three-dimensional coordinates, a three-dimensional size, a rotation angle, a color, and opacity.

20. The non-transitory storage medium according to claim 17, wherein the program code causing the computer to perform the three-dimensional object rendering by using the three-dimensional Gaussian splatting parameters further causes the computer to: perform the three-dimensional object rendering by using the three-dimensional Gaussian splatting parameters through a rasterization-based 3D Gaussian splatting approach.
